(19) United States
(12) Patent Application Publication
(10) Pub. No.: US 2022/0145185 A1
(43) Pub. Date: May 12, 2022

(54) CARBONIZATION/OIL RECOVERY TREATMENT FURNACE

(71) Applicant: Ryoko ITO, Osaka-shi, Osaka (JP)

(72) Inventor: Tomoaki ITO, Osaka (JP)

(21) Appl. No.: 17/433,948

(22) PCT Filed: Jan. 16, 2020
(86) PCT No.: PCT/JP2020/001174

§ 371 Date: Aug. 25, 2021

(30) Foreign Application Priority Data
Feb. 26, 2019 (JP) 2019-033049

(51) Int. Cl. C10B 53/07; C10B 57/16; F27B 5/02

(52) U.S. Cl. CPC C10B 53/07; F27B 5/02; C10B 57/16

(57) ABSTRACT

There is provided a carbonization/oil recovery processing furnace which can be manufactured at a relatively low cost and has less deterioration due to corrosion in association with operation, and can also be maintained and managed at low cost. The carbonization/oil recovery processing furnace is constituted so as to process discarded materials including plastic waste by carbonization and oil recovery with the use of superheated steam which is supplied from the outside, and the carbonization/oil recovery processing furnace is constituted of iron-made external structures and stainless steel-made internal structures which can be separated from the external structures.

### TECHNICAL FIELD

The present invention relates to a carbonization/oil recovery processing furnace which is used for processing discarded materials such as general waste including plastic-derived waste by carbonization and oil recovery.

### BACKGROUND OF THE INVENTION

There is known a method for processing waste by carbonization in which superheated steam is brought into contact with organic waste in an oxygen-free state, and the applicant of the present invention has proposed a waste processing apparatus by carbonization which is used in the processing by carbonization (for example, Patent Literature 1). A processing furnace of the waste processing apparatus by carbonization is constituted of iron or stainless steel.

### PRIOR ART LITERATURE

### Patent Literature

Patent Literature 1: International Publication No: WO2016/185631

### SUMMARY OF THE INVENTION

### Problems to be Solved by the Invention

The above-proposed waste processing apparatus by carbonization can also be used for processing general waste other than organic waste. However, in this case, a consideration must be made for deterioration in the processing furnace due to corrosion by a corrosive gas such as chlorine gas, hydrogen chloride gas, etc., generated from plastic-derived waste such as vinyl chloride contained in general waste. Although stainless steel is less likely to undergo corrosion than iron, it exceeds a service life limit due to advanced corrosion after long-time use.

An object of the present invention is to provide a carbonization/oil recovery processing furnace which can be manufactured at a relatively low cost and which has less deterioration due to corrosion in association with operation, and can also be maintained and managed at low cost.

### Means for Solving the Problem

In order to solve the above problem, the present invention is constituted as follows. That is, the carbonization/oil recovery processing furnace according to the present invention is a furnace which processes discarded materials including plastic waste by carbonization and oil recovery with the use of superheated steam that is supplied from the outside and characterized in that it is constituted of an iron-made external structure and a stainless steel-made internal structure which can be separated from the external structure.

The above-constituted carbonization/oil recovery processing furnace is constituted of a two-layer structure in which the external structure is made of iron relatively low in cost and the internal structure is made of stainless steel relatively high in resistance to a corrosive gas. The external structure is made of iron and can be manufactured at a relatively low cost, and the internal structure is made of stainless steel, thereby suppressing corrosion by a corrosive gas in association with operation. Where corrosion advances to a certain extent in the internal structure due to long-term operation, only the internal structure needs to be replaced. The internal structure can be separated from the external structure, which makes it possible to replace the internal structure. As described above, since it is only necessary to replace a part of the carbonization/oil recovery processing furnace instead of manufacturing a new carbonization/oil recovery processing furnace, this makes it possible to maintain and manage the carbonization/oil recovery processing furnace at low cost.

The internal structure may be fitted to the inside of the external structure so as to be put in and taken out. In this case, the internal structure can be replaced easily.

Further, the internal structure may be constituted of furnace linings which are divided into a plurality and the plurality of furnace linings are fixed to an inner surface of the external structure so as not to be in contact with each other in a normal temperature state. In this case, the internal structure is replaced by replacing each furnace lining. The plurality of furnace linings are fixed to the inner surface of the external structure so as to be spaced appropriately with each other in a normal temperature state, by which stainless steel with a larger thermal expansion coefficient than iron expands during operation and the furnace linings are made to contact each other without spaces, thus making it possible to keep the external structure in an oxygen-free state.

The carbonization/oil recovery processing furnace of the present invention may be provided with a furnace main body, an upper portion of which is open and a lid which closes an upper opening of the furnace main body, and at least the furnace main body may be constituted of the external structure and the internal structure. In this case, the internal structure can be easily replaced by moving the internal structure up and down with respect to the external structure.

### Effects of the Invention

The carbonization/oil recovery processing furnace according to the present invention is a furnace which processes discarded materials including plastic waste by carbonization and oil recovery with the use of superheated steam that is supplied from the outside and constituted of an iron-made external structure and a stainless steel-made internal structure which can be separated from the external structure and, therefore, can be manufactured at a relatively low cost and has less deterioration due to corrosion in association with operation, and can also be maintained and managed at low cost.

### BRIEF DESCRIPTION OF DRAWINGS

FIG. 1 is a longitudinal sectional view of a carbonization/oil recovery processing furnace according to a preferred embodiment of the present invention.

FIG. 2 is a view which shows a state that an internal structure of a furnace main body of the carbonization/oil recovery processing furnace is replaced.

FIG. 3 is a view which shows a state that an internal structure of a lid of the carbonization/oil recovery processing furnace is replaced.

FIG. 4 is a longitudinal sectional view of a carbonization/oil recovery processing furnace according to a different preferred embodiment of the present invention.

FIG. 5(a) is a view which shows a normal temperature state of furnace linings of the carbonization/oil recovery processing furnace, and (b) is a view which shows a state thereof during operation.

FIG. 6 is a view which shows a state that the furnace linings as the internal structure of the furnace main body of the carbonization/oil recovery processing furnace are replaced.

FIG. 7 is a view which shows a state that the furnace linings as the internal structure of the lid of the carbonization/oil recovery processing furnace are replaced.

### MODE OF CARRYING OUT THE INVENTION

Hereinafter, a description will be given of a preferred embodiment of the present invention with reference to drawings.

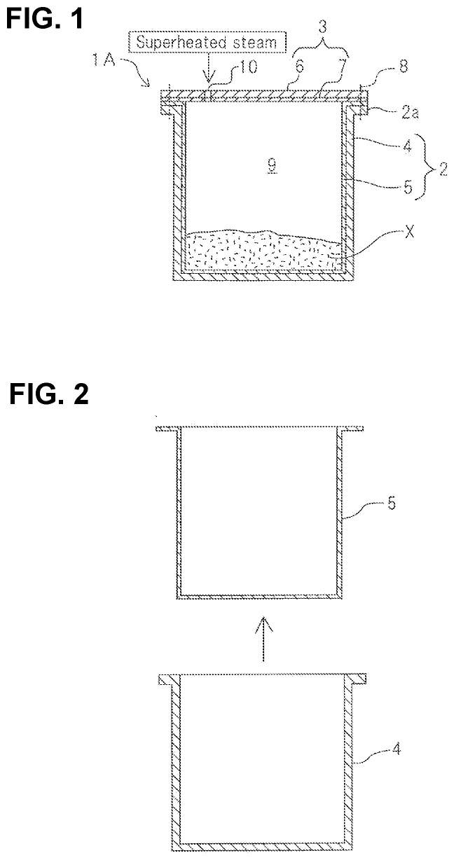

FIG. 1 is a longitudinal sectional view of a carbonization/oil recovery processing furnace according to a preferred embodiment of the present invention. The carbonization/oil recovery processing furnace 1A is constituted of a furnace main body 2, an upper portion of which is open, and a lid 3 which closes an upper opening of the furnace main body 2. The furnace main body 2 is constituted of an iron-made external structure 4 and a stainless steel-made internal structure 5 which is fitted to the inside of the external structure 4. The internal structure 5 is pulled upward, by which the internal structure 5 can be separated from the external structure 4. The lid 3 is constituted of an iron-made external structure 6 and a stainless steel-made internal structure 7 which overlap each other. The external structure 6 and the internal structure 7 of the lid 3 can also be separated from each other.

A collar-like portion 2a which protrudes outwardly is formed at an upper end of the furnace main body 2. The collar-like portion 2a is joined with an outer peripheral portion of the lid 3 by using a joining unit 8 such as a bolt, by which the furnace main body 2 is made integral with the lid 3. Thereby, a furnace space 9 which is surrounded by the furnace main body 2 and the lid 3 is kept in a hermetic state.

The lid 3 is provided with a hot water/steam supplying port 10. The hot water/steam supplying port 10 is connected to a superheated steam supplying unit set outside (not shown) and superheated steam from the superheated steam supplying unit is supplied from the hot water/steam supplying port 10 to the furnace space 9. It is noted that the furnace main body 2 or the lid 3 is provided with an exhaust port (not shown) for discharging air of the furnace space 9 on supplying the superheated steam.

A description will be given of a method for processing discarded materials by the carbonization/oil recovery processing furnace 1A.

The lid 3 is removed and discarded materials X are fed into the furnace space 9. Then, the lid 3 is attached to the furnace main body 2 to supply superheated steam to the furnace space 9. A temperature of the superheated steam is about 300° C. to 600° C. When the furnace space 9 is filled with the superheated steam, the furnace space 9 is kept in an oxygen-free state. In the oxygen-free state, the discarded materials X are brought into contact with the superheated steam at a high temperature, by which organic waste is subjected to carbonization and also plastic-derived waste is subjected to oil recovery. Carbonized substances and oils generated from the carbonization/oil recovery processing are collected and recycled.

Where the discarded materials X contain plastic-derived waste, a corrosive gas such as a chlorine gas, a hydrogen chloride gas, etc., is generated from the plastic-derived waste. The internal structures 5, 7 which are exposed to a corrosive gas are made of stainless steel and stainless steel is relatively high in resistance to a corrosive gas and, therefore, the internal structures 5, 7 are less likely to undergo corrosion. The external structures 4, 6 are covered with the internal structures 5, 7 and kept in an oxygen-free state and, therefore, do not undergo corrosion even when a corrosive gas is present in the furnace space 9.

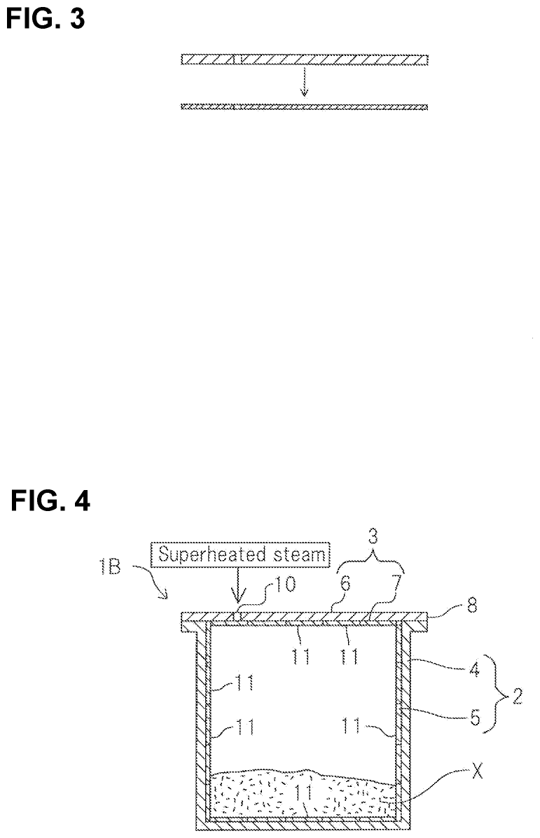

However, corrosion advances in the stainless steel-made internal structures 5, 7 when they are operated for a long time. When corrosion advances to a certain extent, the internal structures 5, 7 are replaced. The furnace main body 2 of the carbonization/oil recovery processing furnace 1A is constituted so that the internal structure 5 is fitted to the inside of the external structure 4. Thus, as shown in FIG. 2, the internal structure 5 is pulled upward in relation to the external structure 4, by which the internal structure 5 can be replaced easily. Further, as shown in FIG. 3, in the case of the lid 3, the internal structure 7 is removed from the external structure 6, by which the internal structure 7 can be easily replaced.

In the carbonization/oil recovery processing furnace 1A, the furnace main body 2 and the lid 3 both have a two-layer structure. The external structures 4, 6 are made of iron which is relatively low in cost, while the internal structures 5, 7 are made of stainless steel which is relatively high in resistance to a corrosive gas. The external structures 4, 6 are made of iron and can be manufactured at a relatively low cost, and the internal structures 5, 7 are made of stainless steel, by which it is possible to suppress corrosion by a corrosive gas in association with operation. Where corrosion advances to a certain extent in the internal structures 5, 7 due to long-term operation, only the internal structures 5, 7 are replaced. As described so far, since it is only necessary to replace a part of the carbonization/oil recovery processing furnace instead of manufacturing a new carbonization/oil recovery processing furnace, the carbonization/oil recovery processing furnace 1A can be maintained and managed at low cost.

FIG. 4 is a longitudinal sectional view of a carbonization/oil recovery processing furnace according to a different preferred embodiment of the present invention. In the carbonization/oil recovery processing furnace 1B, internal structures 5, 7 are constituted of plate-like furnace linings 11 which are divided into a plurality. The furnace linings 11 are made of stainless steel.

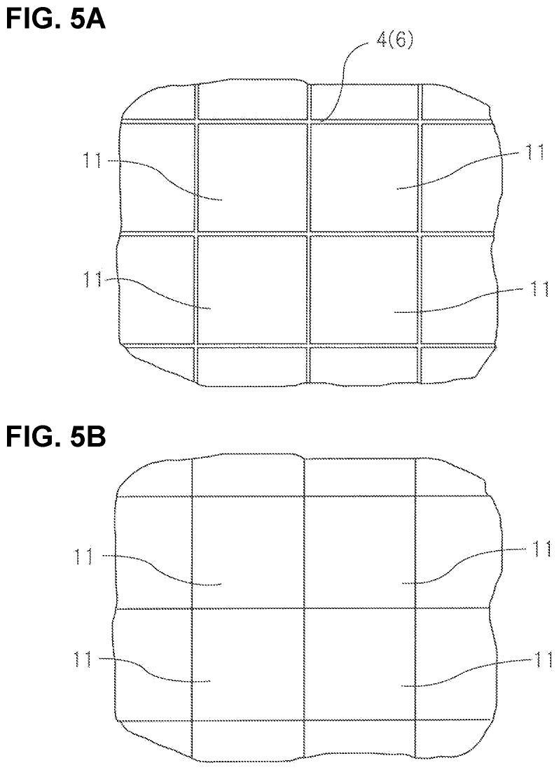

As shown in FIG. 5(a), the furnace linings 11 are each fixed to inner surfaces of the external structures 4, 6 so as not to be in contact with each other at a normal temperature. Stainless steel is larger in thermal expansion coefficient than iron and, therefore, when a temperature is elevated during operation, as shown in FIG. 5(b), an end surface portion of each of the furnace linings 11 is kept in contact with each other. Therefore, the external structures 4, 6 are not exposed to a corrosive gas, by which the external structures 4, 6 are prevented from corrosion.

The plate-like furnace linings 11 which are divided into a plurality may be each constituted as follows. There is provided a port portion through which a support member different in height of attachment to the external structures 4, 6 penetrates, the port portion is inserted into the support member, an end surface of each of the plate-like furnace linings is in contact with an upper portion and a lower portion thereof alternately only by a difference in height so that each of the adjacent furnace linings 11 is not equal in height, and the furnace linings are attached by means of welding, etc., via the support member. In this case, even on expansion of each of the furnace linings due to thermal expansion, an end portion of each of the furnace linings 11 overlaps each other to cover the external structures 4, 6 and the end surfaces thereof come into contact with each other to the extent necessary. Therefore, it is possible to easily arrange the furnace linings, with expansion coefficient taken into consideration.

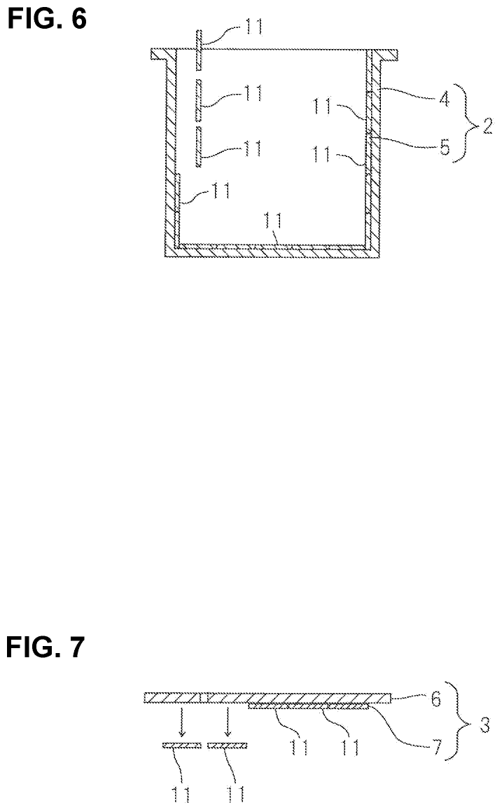

As with the previously described carbonization/oil recovery processing furnace 1A, the carbonization/oil recovery processing furnace 1B also processes discarded materials X by carbonization and oil recovery. When corrosion advances to a certain extent in the internal structures 5, 7, the internal structures 5, 7 are replaced. As shown in FIG. 6 and FIG. 7, the internal structures 5, 7 are replaced by replacing the furnace linings 11. In this case as well, since it is only necessary to replace apart of the carbonization/oil recovery processing furnace instead of manufacturing a new carbonization/oil recovery processing furnace, the carbonization/oil recovery processing furnace 1B can be maintained and managed at low cost.

Each of the carbonization/oil recovery processing furnaces 1A, 1B according to the above-described preferred embodiments is constituted of the furnace main body 2 and the lid 3 and designed so that discarded materials X are fed into the furnace space 9 from above. However, they may be fed into the furnace space 9 from the lateral side thereof. Further, if discarded materials can be put into the furnace space and taken out therefrom, the furnace may be constituted so as to be free of the lid.

### DESCRIPTION OF SYMBOLS

1A, 1B: Carbonization/oil recovery processing furnace

2: Furnace main body

3: Lid

4, 6: External structure

5, 7: Internal structure

11: Furnace linings

X: Discarded materials

1. A carbonization/oil recovery processing furnace which processes discarded materials including plastic waste by carbonization and oil recovery with the use of superheated steam which is supplied from the outside,
the carbonization/oil recovery processing furnace comprising: an iron-made external structure and a stainless steel-made internal structure which can be separated from the external structure.

2. The carbonization/oil recovery processing furnace according to claim 1, wherein the internal structure is fitted to the inside of the external structure so as to be put in and taken out.

3. The carbonization/oil recovery processing furnace according to claim 1, wherein the internal structure is constituted of furnace linings which are divided into a plurality and the plurality of furnace linings are fixed to an inner surface of the external structure so as not to be in contact with each other at a normal temperature.

4. The carbonization/oil recovery processing furnace according to any one of claim 1 including a furnace main body, an upper portion of which is open and a lid which closes an upper opening of the furnace main body, wherein at least the furnace main body is constituted of the external structure and the internal structure.

5. The carbonization/oil recovery processing furnace according to any one of claim 2 including a furnace main body, an upper portion of which is open and a lid which closes an upper opening of the furnace main body, wherein at least the furnace main body is constituted of the external structure and the internal structure.

6. The carbonization/oil recovery processing furnace according to any one of claim 3 including a furnace main body, an upper portion of which is open and a lid which closes an upper opening of the furnace main body, wherein at least the furnace main body is constituted of the external structure and the internal structure.
